(19) United States
(12) Patent Application Publication
(10) Pub. No.: US 2023/0023993 A1
(43) Pub. Date: Jan. 26, 2023

(54) MULTIPLE CURRENCY CONVERSIONS IN ONLINE MARKETPLACES

(71) Applicant: eBay Inc., San Jose, CA (US)

(72) Inventors: Phanisri Kuchibotla, Union City, CA (US); David Gandhi, San Jose, CA (US); Scott Sharp, San Jose, CA (US); Anang Mahesh Mankad, Union City, CA (US); Rashmi Singhal, San Carlos, CA (US); Roopa Jignesh Patel, San Jose, CA (US)

(73) Assignee: eBay Inc., San Jose, CA (US)

(21) Appl. No.: 17/384,147

(22) Filed: Jul. 23, 2021

(51) Int. Cl. G06Q 20/38; G06Q 20/40; G06Q 20/12

(52) U.S. Cl. CPC G06Q 20/381; G06Q 20/4016; G06Q 20/12

(57) ABSTRACT

Systems and method directed to performing a single checkout process using multiple currencies are described. More specifically, a first item total in a first currency type may be displayed at a first location in a user interface and a second item total in a second currency type may be displayed at a second location in the user interface. In response to receiving a determination of a third currency type associated with a buyer of one or more items associated with the first currency type and one or more items associated with the second currency type, a transaction total including a currency transaction fee associated with converting the first currency type to the third currency type and a second currency transaction fee associated with converting the second currency type to the third currency type is displayed at the user interface.

### BACKGROUND

The desire of buyers and sellers to use non-nationally recognized currencies, such as cryptocurrencies and mobile carrier airtime minutes, in financial transactions has created many problems for online marketplaces and third-party payment processors. Online marketplaces and/or third party payments services tend to require nationally recognized currencies when performing currency transactions to reduce currency exchange risk. Currency exchange risks refer to the losses that a financial transaction may incur due to currency fluctuations. Currency exchange risks often arise when a company or individual engages in financial transactions denominated in a currency other than the currency where that company or individual is based. Any appreciation/depreciation of the base currency or the depreciation/appreciation of the denominated currency may affect the flow of currency in that transaction.

Online marketplaces and third-party payment providers are well adapted to handling single currency transactions and even dual currency transactions with limited risk. For example, a buyer may checkout using a single currency common to the buyer and the seller, or upon checkout, a third-party payment system may convert a first currency held by the buyer into a second currency desired by the seller. However, in order for the buyer to purchase an item sold in the second currency and an item sold in a third currency, the online shopping experience would require the buyer to go through the checkout process two separate times. During a first checkout process, a third-party payment system would convert the first currency held by the buyer into the second currency desired by the seller of the first item, and then during the second separate checkout process, the third-party payment system would convert the first currency held by the buyer into the third currency desired by the seller of the second item. Be it that two separate checkouts occur, the buyer is twice as likely to encounter a problem and/or get distracted and only perform one purchase, thereby potentially limiting the shopping experience with one of the sellers. Existing marketplace checkout environments do not provide an option for a buyer to perform a single checkout process to purchase a first item in a non-nationally recognized currency, such as mobile carrier airtime minutes or some cryptocurrencies, and a second item in a nationally recognized currency, such as the U.S. dollar or Philippine Peso.

It is with respect to these and other general considerations that embodiments have been described. Although relatively specific problems have been discussed, it should be understood that the examples described herein should not be limited to solving the specific problems identified in the background above.

### SUMMARY

In accordance with at least one example of the present disclosure, a method for performing a single checkout process using multiple currencies, is provided. The method may include dynamically displaying a first item total in a first currency type at a first location in a user interface, the first item total indicating a subtotal for one or more items associated with the first currency type; dynamically displaying a second item total in a second currency type at a second location in the user interface, the second item total indicating a subtotal for one or more items associated with the second currency type; and in response to receiving a determination of a third currency type associated with a buyer of the one or more items associated with the first currency type and the one or more items associated with the second currency type, dynamically displaying a transaction total including a currency transaction fee associated with converting the first currency type to the third currency type and a second currency transaction fee associated with converting the second currency type to the third currency type.

In accordance with at least one example of the present disclosure, a method for performing a single checkout process using multiple currencies is provided. The method may include receiving a first item total in a first currency type, the first item total indicating a subtotal for one or more items associated with the first currency type; receiving a second item total in a second currency type, the second item total indicating a subtotal for one or more items associated with the second currency type; and in response to receiving a third currency type associated with a buyer of the one or more items associated with the first currency type and the one or more items associated with the second currency type, dynamically displaying a transaction total including a currency transaction fee associated with converting the first currency type to the third currency type and a second currency transaction fee associated with converting the second currency type to the third currency type.

In accordance with at least one example of the present disclosure, a system is provided. The system may include a processor; and memory including instructions, which when executed by the processor, cause the processor to: dynamically display a first item total in a first currency type at a first location in a user interface, the first item total indicating a subtotal for one or more items associated with the first currency type; dynamically display a second item total in a second currency type at a second location in the user interface, the second item total indicating a subtotal for one or more items associated with the second currency type; and in response to receiving a determination of a third currency type associated with a buyer of the one or more items associated with the first currency type and the one or more items associated with the second currency type, dynamically display a transaction total including a currency transaction fee associated with converting the first currency type to the third currency type and a second currency transaction fee associated with converting the second currency type to the third currency type.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts a first user interface of a checkout and payment process in accordance with examples of the present disclosure.

FIG. 2A depicts a second user interface of a checkout and payment process in accordance with examples of the present disclosure.

FIG. 2B depicts a third user interface of a checkout and payment process in accordance with examples of the present disclosure.

FIG. 2C depicts a third user interface of a checkout and payment process in accordance with examples of the present disclosure.

FIG. 2D depicts a fourth user interface of a checkout and payment process in accordance with examples of the present disclosure.

FIG. 3A depicts examples of risk profiles associated with various currencies in accordance with examples of the present disclosure.

FIG. 3B depicts examples of risk profiles associated with various currency pairs in accordance with examples of the present disclosure.

FIG. 4 depicts example ledger transactions in accordance with examples of the present disclosure.

FIG. 5 depicts a risk profile generator and currency converter in accordance with examples of the present disclosure.

FIG. 6 depicts details of a first method for performing a currency transaction involving multiple currencies in accordance with examples of the present disclosure.

FIG. 7 depicts details of a second method for performing a currency transaction involving multiple currencies in accordance with examples of the present disclosure.

FIG. 8 illustrates a simplified block diagram of a device with which aspects of the present disclosure may be practiced in accordance with aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Currency exchange risks refer to the losses that a financial transaction may incur due to currency fluctuations. Currency exchange risks often arise when a company or individual engages in financial transactions denominated in a currency other than the currency where that company or individual is based. Any appreciation/depreciation of the base currency or the depreciation/appreciation of the denominated currency may affect the flow of currency in that transaction. emanating from that transaction. Often times a seller may limit their risk and/or exposure to currency exchange risk by accepting, in exchange for goods and services, a single currency according to where the seller is based. For example, a transaction occurring between the seller and the buyer may require the buyer to pay the seller in the seller's desired currency. Alternatively, or in addition, the buyer or seller may convert currency provided by the buyer into a currency accepted by the seller by converting the currency at a physical currency exchange or rely on a third-party payment agency, such as a credit agency, to do the currency conversion for them. In such instances where the buyer or seller use a physical currency exchange, effort is required on the part of the seller or buyer (e.g., physically locating and going to a currency exchange, and then exchanging currency at the currency exchange's rate) to perform the conversion. When a third-party payment agency, such as a credit agency, performs the conversion, the conversion rate and transaction fee may be unbeknownst to the buyer and seller until many days after the transaction occurred. By only accepting a single type of currency, the seller may be losing business from potential buyers that do not possess the currency and/or do not wish to go through the extra steps involved to obtain the currency. By only holding a single currency, buyers may miss out on goods and services.

Similar problems exist in online marketplaces that provide goods and services for purchase from sellers in one or more countries by buyers in one or more different countries. For example, an on-line marketplace may operate in various locations throughout the world and therefore may be exposed to transactions in multiple currencies. Online marketplaces are well adapted to handling single currency transactions and even dual currency transaction. For example, a buyer may checkout using a single currency common to the buyer and the seller, or upon checkout, a third-party payment system may convert a first currency held by the buyer into a second currency desired by the seller. However, in order for the buyer to purchase an item sold in the second currency and an item sold in a third currency, the online shopping experience would require the buyer to go through the checkout process two separate times and have a third-party payment system convert the first currency held by the buyer into the second currency desired by the seller of the first item and then separately have the third-party payment system convert the first currency held by the buyer into the third currency desired by the seller of the second item. Be it that two separate checkouts occur, the buyer is twice as likely to encounter a problem and/or get distracted and only perform one purchase, thereby potentially limiting the shopping experience with one of the sellers.

In examples, a multicurrency online shopping experience is described that provides opportunities for sellers to showcase their goods and services without regard to the type of currency involved in the transaction. Further, the multicurrency online shopping experience provides opportunities for buyers to purchase goods and services denominated in difference currencies in a single checkout process.

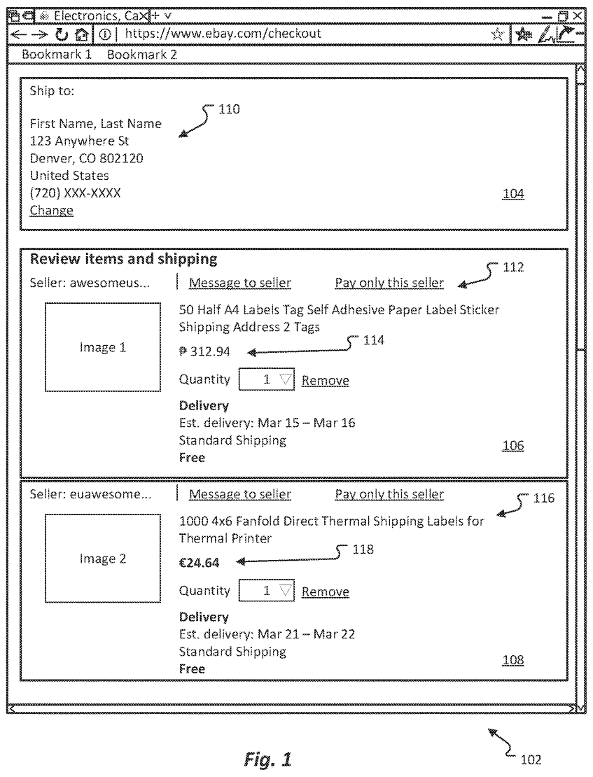

FIG. 1 depicts a first user interface 102 of a checkout and payment process in accordance with examples of the present disclosure. More specifically, the first user interface 102 may include a first panel 104, a second panel 106, and a third panel 108. The first panel 104 may include details related to a buyers shipping address 110. The second panel 106 and third panel 108 may include details of one or more items added to a virtual shopping cart of the buyer. For example, the first panel 106 may include a first item 112 denominated in a first currency 114, such as the Philippine Peso. The third panel 108 may include a second item 116 denominated in a second currency 118, such as the Euro. The first currency 114 is different from the second currency 118. Rather than purchasing the first item 112 and the second item 116 in two separate transactions, examples of the present disclosure provide the ability for a buyer to purchase both items denominated in difference currencies in a single transaction.

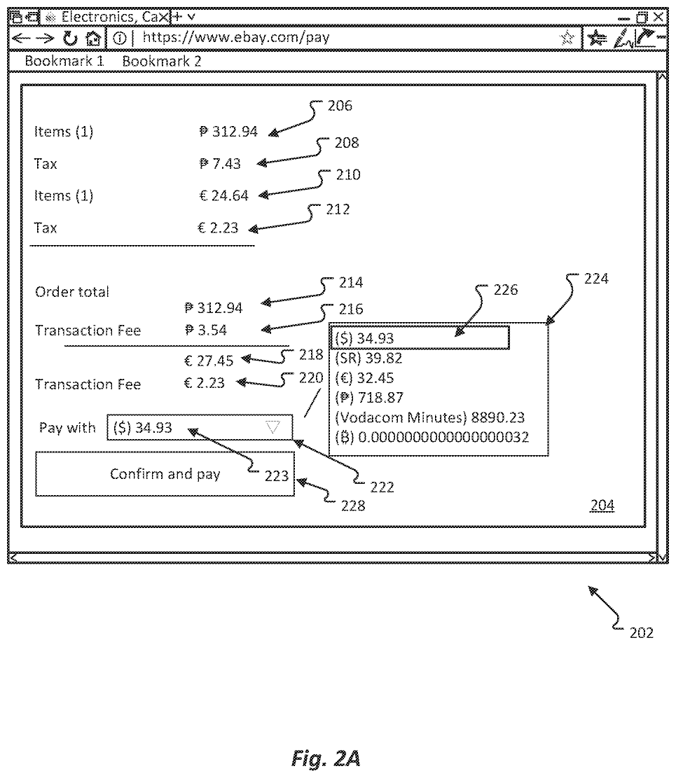

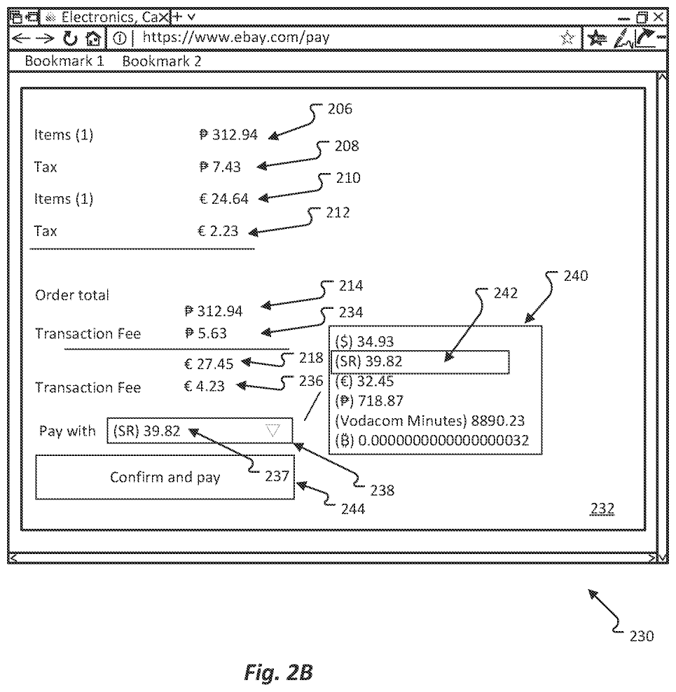

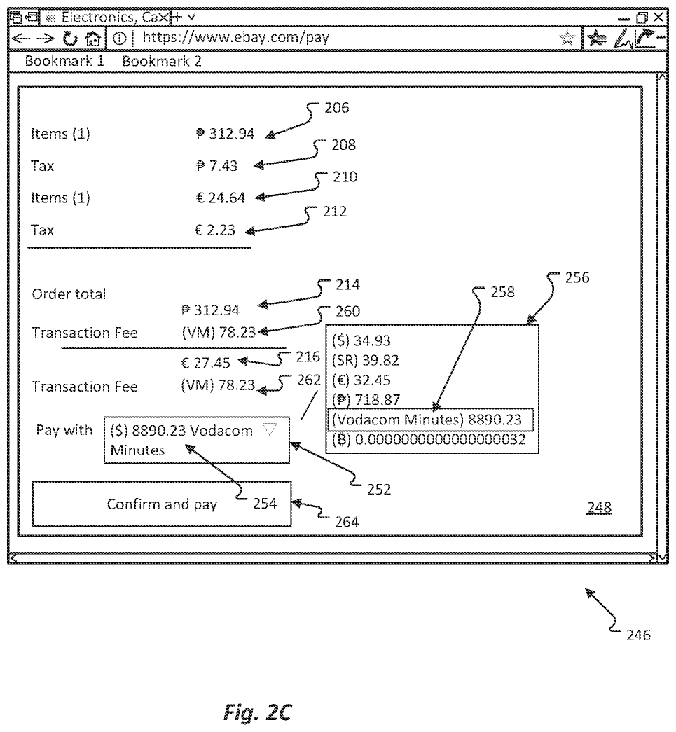

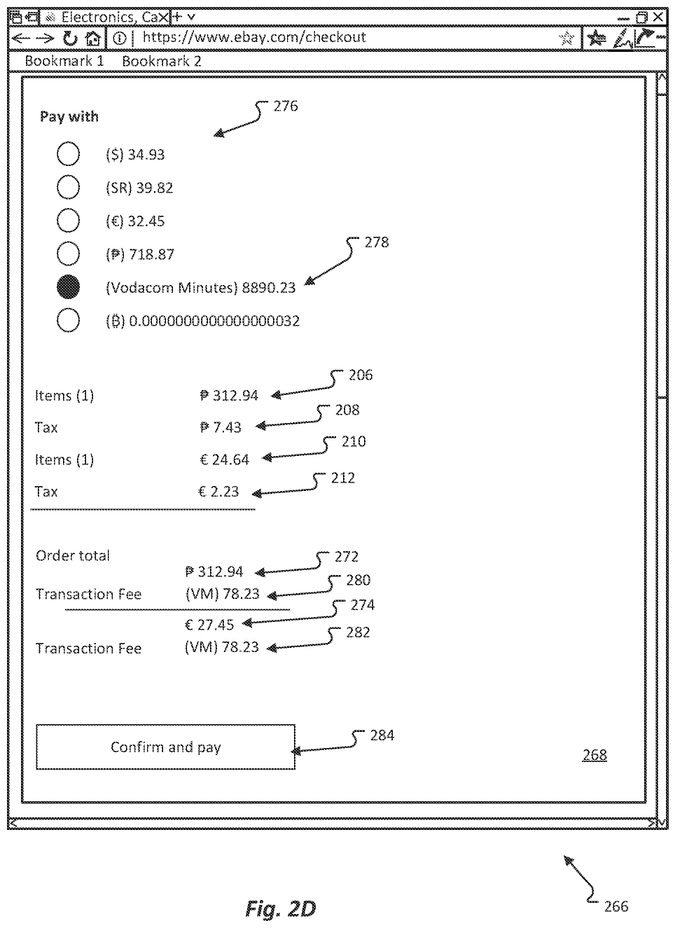

FIG. 2A depicts a second user interface 202 of a checkout and payment process in accordance with examples of the present disclosure. The second user interface 202 may include a first panel 204 providing an overview or summary of the currencies involved for the two items depicted in the panels 106 and 108 of FIG. 1. For example, the item cost 206 for the first item and the tax 208 if any for the first item may be displayed in the panel 204. Additionally, the item cost 210 for the second item and the tax 212 if any for the second item may be displayed in the panel 204. The panel 204 may further include an order total, separated by currency, together with a transaction fee associated with converting the currency specific order total from a first currency to a second currency. For example, an order total 214 may indicate the total cost due to the seller of the first item. The order total 218 may indicate the total cost due to the seller of the second item. As the buyer may be using a currency to purchase the first and second items that is different from the currencies of the first item and the second item, the currency of the buyer will need to be converted to the currency of the seller of the first item and to the currency of the seller of the second item.

As further depicted in the second user interface 202, a control 222 may display a total transaction cost 223 associated with the purchase of both items. The buyer may select the control 222 to change the paying currency. For example, the control 222, when selected, may cause a selection menu 224, such as a dropdown menu, to be presented to the buyer. Displayed in the selection menu 224, are various currencies that the user can select from, where each selection also includes the total transaction cost associated with the purchase of both items for the respective selection. As a buyer selects different currencies 226, different transaction fees 216 and 220 and different total transaction costs 223 may be displayed. Upon selecting the desired currency, the buyer may confirm the selection by selecting the control 228 and cause the online marketplace to debit the total transaction cost 223 from an account associated with the buyer, such as but not limited to an account associated with the online marketplace, a bank account, and the like, and pay at least one of a first seller in a first currency and/or a second seller with a second currency. Alternatively, or in addition, upon selecting the desired currency, the buyer may confirm the selection by selecting the control 228 and cause the online marketplace to charge the total transaction cost 223 to an account associated with the buyer, such as a credit card, gift card, or the like, and pay at least one of a first seller in a first currency and/or a second seller with a second currency.

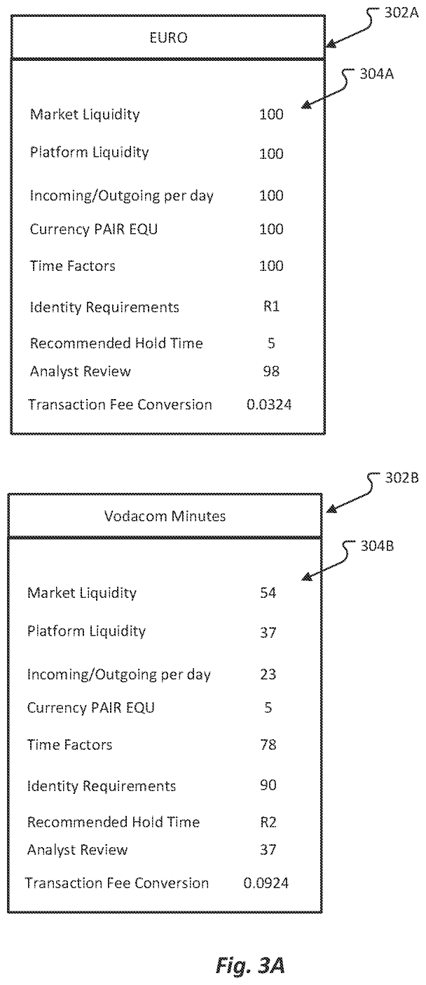

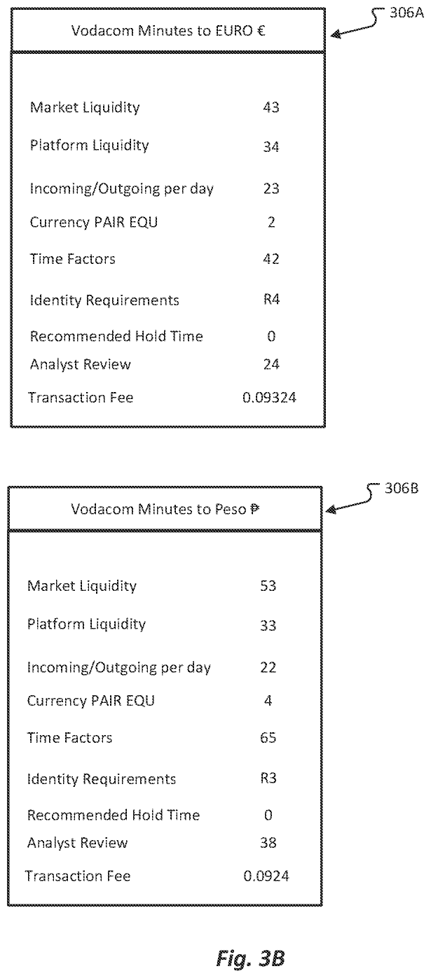

The transaction fees 216 and 220 represent the cost of converting the selected currency 226 into the respective currency for each of the respective items. As will be described with respect to FIGS. 3A-3B, the transaction fee may depend upon various risk factors associated with one or more of the currencies involved in the proposed transaction. In some examples, the transaction fees 216 and 220 represent a maximum transaction fee associated the currency conversion of the proposed transaction; the actual settled transaction fee may be less. When the settled transaction fee is less than the maximum transaction fee, the buyer may be refunded the difference.

As will be further discussed, upon selection of the control 228, at least a portion of the details of the transaction may be provided to a publicly available ledger, providing currency conversion transparency. Accordingly, the maximum transaction fees 216 and 220 may be provided to the publicly available ledger. Upon the settlement of the currency conversions, each settlement transaction cost may be provided to the publicly available ledger. Upon receiving the settlement cost, any refund due to the buyer may be calculated and provided to the ledger. In examples, to facilitate the currency conversions, a smart contract may be used to initiate one or more processes by which currency is converted and/or by which transactions are recorded in the publicly available ledger.

FIG. 2B depicts a third user interface 230 of a checkout and payment process in accordance with examples of the present disclosure. The third user interface 230 may include a first panel 232 providing an overview or summary of the currencies involved for the two items depicted in the panels 106 and 108 of FIG. 1. The third user interface 230 and the first panel 232 may be the same as or similar to the second user interface 202 and the first panel 204 of FIG. 2A, with differences noted by different reference characters. The item cost 206 for the first item and the tax 208 if any for the first item may be displayed in the panel 232. Additionally, the item cost 210 for the second item and the tax 212 if any for the second item may be displayed in the panel 232. The panel 232 may further include an order total, separated by currency, together with a transaction fee associated with converting the currency specific order total from a first currency to a second currency. For example, an order total 214 may indicate the total cost due to the seller of the first item. The order total 218 may indicate the total cost due to the seller of the second item. As the buyer may be using a currency to purchase the first and second items that is different from the currencies of the first item and the second item, the currency of the buyer will need to be converted to the currency of the seller of the first item and to the currency of the seller of the second item.

As further depicted in the third user interface 230, a control 238 may display a total transaction cost 237 associated with the purchase of both items. The buyer may select the control 238 to change the paying currency. For example, the control 238, when selected, may cause a selection menu 240, such as a dropdown menu, to be presented to the buyer. Displayed in the selection menu 240, are various currencies that the user can select from, where each selection also includes the total transaction cost associated with the purchase of both items for the respective selection. As a buyer selects different currencies 242, different transaction fees 216 and 220 and different total transaction costs 237 may be displayed based on the currency conversion rate. Upon selecting the desired currency, the buyer may confirm the selection by selecting the control 244 and cause the online marketplace to debit the total transaction cost 237 from an account associated with the buyer, such as but not limited to an account associated with the online marketplace, a bank account, and the like, and pay a first seller in a first currency and pay a second seller with a second currency. Alternatively, or in addition, upon selecting the desired currency, the buyer may confirm the selection by selecting the control 238 and cause the online marketplace to charge the total transaction cost 237 to an account associated with the buyer, such as a credit card, gift card, or the like, and pay a first seller in a first currency and pay a second seller with a second currency.

The transaction fees 234 and 236 represent the cost of converting the selected currency 242 into the respective currency for each of the respective items. As will be described with respect to FIGS. 3A-3B, the transaction fee may depend upon various risk factors associated with one or more of the currencies involved in the proposed transaction. In some examples, the transaction fees 234 and 236 represent a maximum transaction fee associated the currency conversion of the proposed transaction; the actual settled transaction fee may be less. When the settled transaction fee is less than the maximum transaction fee, the buyer may be refunded the difference.

FIG. 2C depicts a third user interface 246 of a checkout and payment process in accordance with examples of the present disclosure. The third user interface 246 may include a first panel 248 providing an overview or summary of the currencies involved for the two items depicted in the panels 106 and 108 of FIG. 1. The third user interface 246 and the first panel 248 may be the same as or similar to the second user interface 202 and the first panel 204 of FIG. 2A, with differences noted by different reference characters. The item cost 206 for the first item and the tax 208 if any for the first item may be displayed in the panel 248. Additionally, the item cost 210 for the second item and the tax 212 if any for the second item may be displayed in the panel 248. The panel 248 may further include an order total, separated by currency, together with a transaction fee associated with converting the currency specific order total from a first currency to a second currency. For example, an order total 214 may indicate the total cost due to the seller of the first item. The order total 218 may indicate the total cost due to the seller of the second item. As the buyer may be using a currency to purchase the first and second items that is different from the currencies of the first item and the second item, the currency of the buyer will need to be converted to the currency of the seller of the first item and to the currency of the seller of the second item.

As further depicted in the third user interface 246, a control 252 may display a total transaction cost 254 associated with the purchase of both items. The buyer may select the control 252 to change the paying currency. For example, the control 252, when selected, may cause a selection menu 256, such as a dropdown menu, to be presented to the buyer. Displayed in the selection menu 256, are various currencies that the user can select from, where each selection also includes the total transaction cost associated with the purchase of both items for the respective selection. As a buyer selects different currencies 258, different transaction fees 260 and 262 in the selected currency 258 may be displayed based on the currency conversion rate. Upon selecting the desired currency 258, the control 252 may display the updated total transaction cost in the currency of the selected currency 258. The buyer may confirm the selection by selecting the control 264 and cause the online marketplace to debit the total transaction cost 254 from an account associated with the buyer, such as but not limited to an account associated with the online marketplace, a bank account, and the like, and pay a first seller in a first currency and pay a second seller with a second currency. Alternatively, or in addition, upon selecting the desired currency, the buyer may confirm the selection by selecting the control 264 and cause the online marketplace to charge the total transaction cost 254 to an account associated with the buyer, such as a credit card, gift card, or the like, and pay a first seller in a first currency and pay a second seller with a second currency.

The transaction fees 260 and 262 represent the cost of converting the selected currency 258 into the respective currency for each of the respective items. As will be described with respect to FIGS. 3A-3B, the transaction fee may depend upon various risk factors associated with one or more of the currencies involved in the proposed transaction. In some examples, the transaction fees 260 and 262 represent a maximum transaction fee associated the currency conversion of the proposed transaction; the actual settled transaction fee may be less. When the settled transaction fee is less than the maximum transaction fee, the buyer may be refunded the difference.

FIG. 2D depicts a fourth user interface 266 of a checkout and payment process in accordance with examples of the present disclosure. The fourth user interface 266 may include a first panel 268 providing an overview or summary of the currencies involved for the two items depicted in the panels 106 and 108 of FIG. 1. The fourth user interface 266 and the first panel 268 may include similar elements as the second user interface 202 and the first panel 204 of FIG. 2A, where similarities are noted by the same reference characters. The item cost 206 for the first item and the tax 208 if any for the first item may be displayed in the panel 248. Additionally, the item cost 210 for the second item and the tax 212 if any for the second item may be displayed in the panel 268. The panel 268 may further include an order total, separated by currency, together with a transaction fee associated with converting the currency specific order total from a first currency to a second currency. For example, an order total 272 may indicate the total cost due to the seller of the first item. The order total 274 may indicate the total cost due to the seller of the second item. As the buyer may be using a currency to purchase the first and second items that is different from the currencies of the first item and the second item, the currency of the buyer will need to be converted to the currency of the seller of the first item and to the currency of the seller of the second item.

As further depicted in the fourth user interface 266, a user may select from one of a plurality of different currency options 276 displaying a total transaction cost. The buyer may select one of the currency options 276 to change the paying currency. For example, the user may select the currency option 278 resulting in the transaction fees 280 and 282 to be updated reflecting the transaction fees in the selected currency options 278. The buyer may confirm the transaction total by selecting the control 284 and cause the online marketplace to debit the total transaction cost associated with the selected currency 278 from an account associated with the buyer, such as but not limited to an account associated with the online marketplace, a bank account, and the like, and pay a first seller in a first currency and pay a second seller with a second currency. Alternatively, or in addition, upon selecting the desired currency, the buyer may confirm the selection by selecting the control 284 and cause the online marketplace to charge the total transaction cost associated with selected currency 278 to an account associated with the buyer, such as a credit card, gift card, or the like, and pay a first seller in a first currency and pay a second seller with a second currency.

The transaction fees 280 and 282 represent the cost of converting the selected currency 278 into the respective currency for each of the respective items. As will be described with respect to FIGS. 3A-3B, the transaction fee may depend upon various risk factors associated with one or more of the currencies involved in the proposed transaction. In some examples, the transaction fees 280 and 282 represent a maximum transaction fee associated the currency conversion of the proposed transaction; the actual settled transaction fee may be less. When the settled transaction fee is less than the maximum transaction fee, the buyer may be refunded the difference.

FIG. 3A depicts examples of risk profiles associated with various currencies in accordance with examples of the present disclosure. Each risk profile 302 may indicate one or more parameters 304 that are specific to each currency and may be included in calculating a transaction fee conversion to be applied from converting from one currency to another. For example, a rating for market liquidity specific to the currency may be included in the risk profile 302 for each currency. In examples, the online market place may have its own liquidity rating, such as the platform liquidity. In some examples, the currency profile 302 may include an indication as to an amount of currency that comes into or goes out of the online market place as an incoming/outgoing per day rating. In some examples, a currency pairing, one or more long or short term factors rating, recommended hold time, and an analyst review may be included in the transaction fee conversion.

In examples, the currency may be a nationally recognized currencies, such as Euros, Pesos, or Dollars, and non-nationally recognized currencies, such as cryptocurrencies and mobile carrier airtime minutes. Thus, each risk profile 302 may include an identity requirements, or other national requirements, specific to the currency. For example, some nations require online platforms handling transactions compliance with known your customer (e.g., KYC) rules or regulations. Accordingly, the presence of or lack of an identity requirement may influence the transaction fee conversion rate.

FIG. 3B depicts examples of risk profiles associated with various currency pairs in accordance with examples of the present disclosure. Each risk profile 306 may indicate one or more parameters that are specific to each currency pair, where each currency pair may be associated with a currency conversion transaction. For example, converting from Vodacom minutes to Euros may include one or more parameters specific to such conversion, such parameters, similar to the currency parameters of FIG. 3A, may be included in the generation of the transaction conversion fee, where the transaction conversion fee may be a rate which is multiplied by the currency specific transaction costs; such as the order total 214.

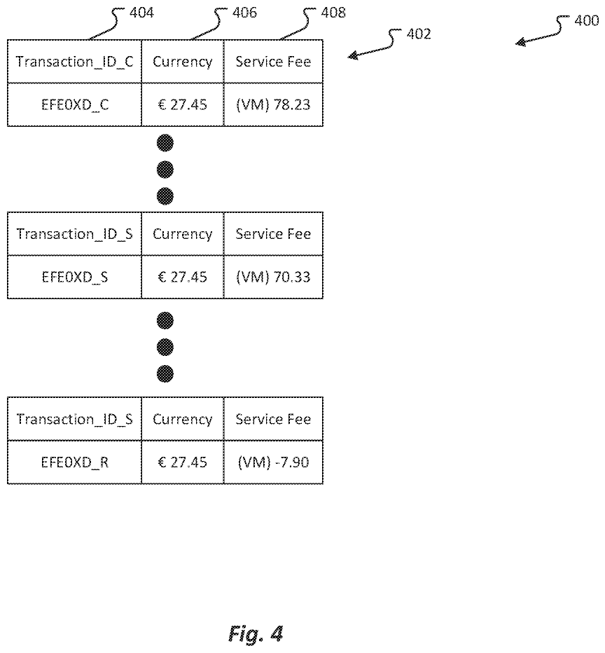

FIG. 4 depicts example ledger transactions 400 in accordance with examples of the present disclosure. More specifically, a first time corresponding to a ledger 402 may include a transaction_ID 404 for a first transaction corresponding to a currency conversion. The first transaction may correspond to an originating currency and amount of the currency 406 and a resulting currency and amount 408. The ledger currencies 406 and 408 associated with the transaction_ID 404 may correspond to an entry associated with a user selecting a confirm and pay control 228. At a second subsequent time, the ledger 402 may include details of a settlement transaction. The settlement transaction may include a transaction ID, the currency and amount of the originating currency, and then the actual service fee, or transaction fee, associated with the conversion. Accordingly, in instances where the service fee in the settlement ledger is less than the service fee in the conversions ledger, then a refund may be issued to the buyer. For example, the ledger 402 may include a transaction identifier indicating a refund of the service. The refund may be provided to the buyer directly in the online marketplace, a bank account, or a credit agency account for example.

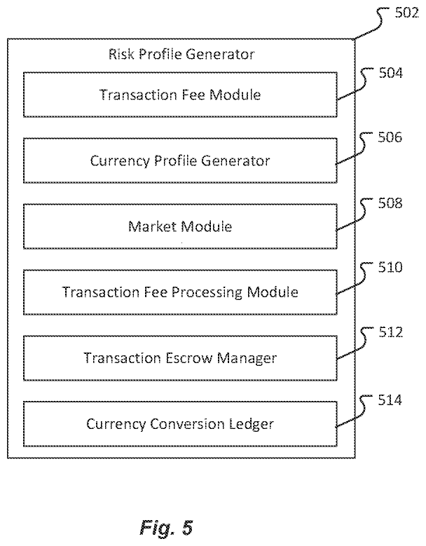

FIG. 5 depicts a risk profile generator and currency converter 502 in accordance with examples of the present disclosure. The risk profile generator and currency converter 502 may include a transaction fee module 504 which may generate a transaction fee, such as the transaction fee 216 of FIG. 2 based on a currency profile generated by a currency profile generator 506. The currency profile generator 506 may generate a currency profile, such as a currency risk profile 302 and/or 306 as previously discussed. The market module 508 may collect market factors, such as one or more current market conditions including currency outlook (e.g., increasing/decreasing) that may affect the currency and the generation of a currency profile The transaction fee processing module 510 may process the transaction fee by tracking the transaction fee at the time of purchase by a buyer, maintaining the transaction fee in an escrow account as handled by the transaction escrow manager 512, and then then causing details of the transaction to be written in a currency conversion ledger 514.

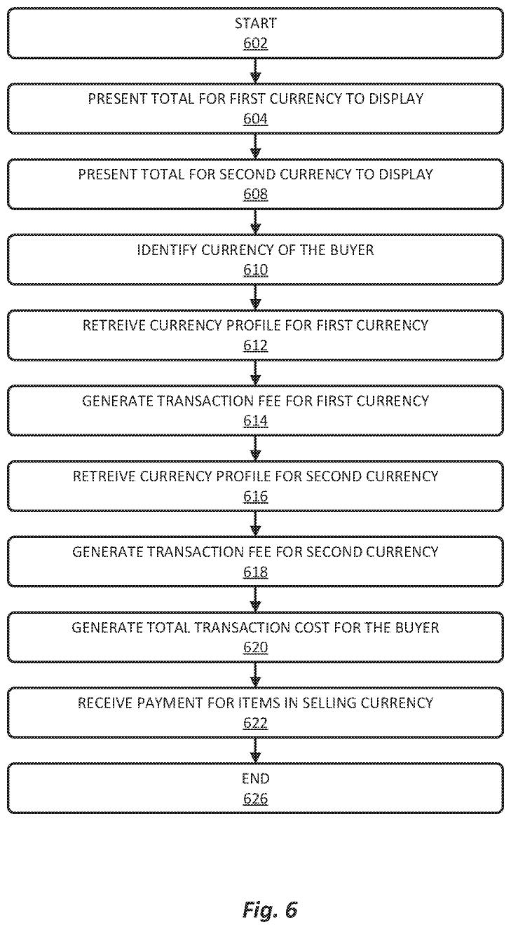

FIG. 6 depicts details of a method 600 for performing a currency transaction involving multiple currencies in accordance with examples of the present disclosure. A general order for the steps of the method 600 is shown in FIG. 6. Generally, the method 600 starts at 602 and ends at 626. The method 600 may include more or fewer steps or may arrange the order of the steps differently than those shown in FIG. 6. The method 600 can be executed as a set of computer-executable instructions executed by a computer system and encoded or stored on a computer readable medium. In examples, aspects of the method 600 are performed by one or more processing devices, such as a computer or server. Further, the method 600 can be performed by gates or circuits associated with a processor, Application Specific Integrated Circuit (ASIC), a field programmable gate array (FPGA), a system on chip (SOC), a neural processing unit, or other hardware device. Hereinafter, the method 600 shall be explained with reference to the systems, components, modules, software, data structures, user interfaces, etc. described in conjunction with FIGS. 1-5.

The method starts at 602, where flow may proceed to 604 where a first currency total for a transaction provided to a display. For example, the first currency total may be the first order total 214 of FIG. 2. At 608, a second currency total for a transaction is provided to a display. For example, the second currency total may be the second order total 218 of FIG. 2. The method may proceed to 610 where a currency of the buyer may be determined or otherwise identified. In examples, the currency of the buyer may correspond to a currency indicated in a user account of the buyer. In some examples, the currency may be associated with a shipping address or country identified in the shipping address. In other instance, the currency of the buyer may be a selection as indicated by the buyer. For example, the buyer may select a currency from a selection menu 224 (FIG. 2). The method 600 may proceed to 612, where a currency profile may be retrieved for the first currency. For example, a currency profile corresponding to the currency profile 302 (FIG. 3) may be retrieved. In examples, the currency profile may correspond to a transaction currency pair profile, such as a profile 306. The profile 306 may be based on the originating currency (e.g., the buyer's currency) and the seller's currency (e.g., the currency of the seller). The method may proceed to 614 where a transaction fee is generated based on the currency profile.

The method 600 may proceed to 616, where a currency profile may be retrieved for the first currency. For example, a currency profile corresponding to the currency profile 302 (FIG. 3) may be retrieved. In examples, the currency profile may correspond to a transaction currency pair profile, such as a profile 306. The profile 306 may be based on the originating currency (e.g., the buyer's currency) and the seller's currency (e.g., the currency of the seller). The method may proceed to 618 where a transaction fee is generated based on the currency profile. The method 600 may proceed to 620 where a total transaction cost is generated and payment is received from the buyer. At 622, currency representative of the item cost may be provided to the seller at 622. The method 600 may end at 626.

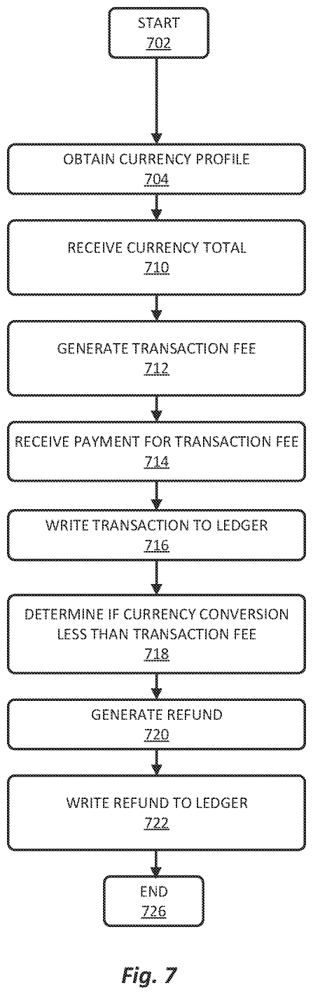

FIG. 7 depicts details of a method 700 for performing a currency transaction involving multiple currencies in accordance with examples of the present disclosure. A general order for the steps of the method 700 is shown in FIG. 7. Generally, the method 700 starts at 702 and ends at 726. The method 700 may include more or fewer steps or may arrange the order of the steps differently than those shown in FIG. 7. The method 700 can be executed as a set of computer-executable instructions executed by a computer system and encoded or stored on a computer readable medium. In examples, aspects of the method 700 are performed by one or more processing devices, such as a computer or server. Further, the method 700 can be performed by gates or circuits associated with a processor, Application Specific Integrated Circuit (ASIC), a field programmable gate array (FPGA), a system on chip (SOC), a neural processing unit, or other hardware device. Hereinafter, the method 700 shall be explained with reference to the systems, components, modules, software, data structures, user interfaces, etc. described in conjunction with FIGS. 1-6.

The method starts at 702, where flow may proceed to 704 where a currency profile is obtained for a specific currency. For example, a currency profile corresponding to the currency profile 302 (FIG. 3) may be retrieved. In examples, the currency profile may correspond to a transaction currency pair profile, such as a profile 306. The profile 306 may be based on the originating currency (e.g., the buyer's currency) and the seller's currency (e.g., the currency of the seller). The method may proceed to 710 where a transaction total for the currency received at 704 is obtained. For example, the transaction total may include the order total 214 (FIG. 2). The method may proceed to 712, where a transaction fee is generated based on the currency profile. At 714, payment for the transaction fee is received. In example, the payment may be received from the buyer in the buyer's currency. The amount of the transaction fee and the currency may be recorded to a ledger 716. The ledger 716 may be the same as or similar to the ledger of FIG. 4. At 718, and once the currency conversion has settled, the actual transaction fee may be written to the ledger such that a difference between the transaction fee paid by the buyer and the actual transaction fee may be determined. If a refund is determined to be available (e.g., the actual transaction fee is less than the transaction fee paid by the buyer), the method may proceed to 720 where a refund is generated. The amount of the refund may be written to the ledger at 722. The method may end at 700.

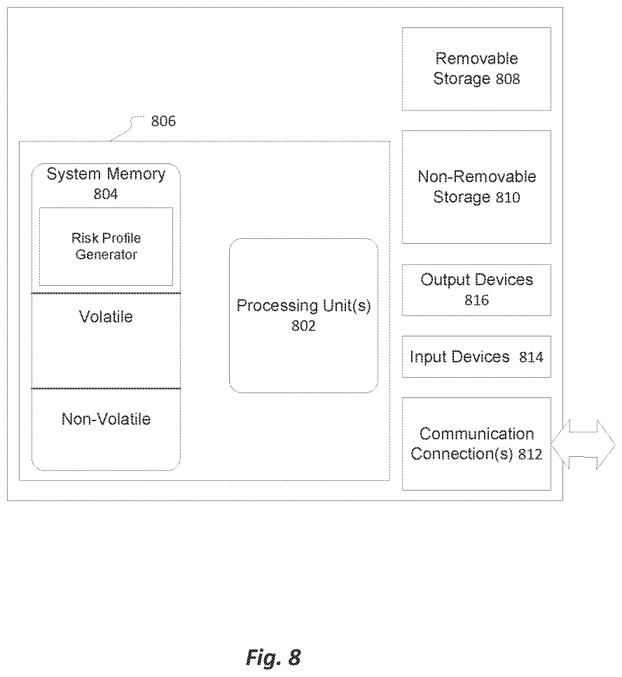

FIG. 8 illustrates a simplified block diagram of the device with which aspects of the present disclosure may be practiced in accordance with aspects of the present disclosure. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 may be volatile (such as RAM), non-volatile (such as ROM, flash memory, etc.), or some combination of the two and may include one or more instructions to implemented the risk profile generator as described in FIG. 5. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as keyboard, mouse, pen, voice input, on-board sensors, etc. and/or output device(s) 816 such as a display, speakers, printer, motors, etc. Also included in the environment may be one or more communication connections, 812, such as LAN, WAN, a near-field communications network, point to point, etc.

Operating environment 800 typically includes at least some form of computer readable media. Computer readable media can be any available media that can be accessed by at least one processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which of the present disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The present disclosure relates to systems and methods for performing a single checkout process using multiple currencies according to at least the examples provided in the sections below:

At least one aspect of the present disclosure is directed to a method for performing a single checkout process using multiple currencies, the method comprising: dynamically displaying a first item total in a first currency type at a first location in a user interface, the first item total indicating a subtotal for one or more items associated with the first currency type; dynamically displaying a second item total in a second currency type at a second location in the user interface, the second item total indicating a subtotal for one or more items associated with the second currency type; and in response to receiving a determination of a third currency type associated with a buyer of the one or more items associated with the first currency type and the one or more items associated with the second currency type, dynamically displaying a transaction total including a currency transaction fee associated with converting the first currency type to the third currency type and a second currency transaction fee associated with converting the second currency type to the third currency type.

In accordance with at least one aspect of the above method, the method may include dynamically displaying the currency transaction fee associated with converting the first currency type to the third currency type in the user interface; and dynamically displaying the currency transaction fee associated with converting the second currency type to the third currency type in the user interface. In accordance with at least one aspect of the above method, the currency transaction fee associated with converting the first currency type to the third currency type is displayed as the third currency type, and the currency transaction fee associated with converting the second currency type to the third currency type is displayed as the third currency type. In accordance with at least one aspect of the above method, the currency transaction fee associated with converting the first currency type to the third currency type is displayed as the first currency type, and the currency transaction fee associated with converting the second currency type to the third currency type is displayed as the second currency type. In accordance with at least one aspect of the above method, the method includes receiving a determination of a fourth currency type associated with a buyer of the one or more items associated with the first currency type and the one or more items associated with the second currency type, displaying a second transaction total including a currency transaction fee associated with converting the first currency type to the fourth currency type and a second currency transaction fee associated with converting the second currency type to the fourth currency type. In accordance with at least one aspect of the above method at least one of the first currency type, the second currency type, and the third currency type is a non-nationally recognized currency. In accordance with at least one aspect of the above method the least one of the first currency type, the second currency type, and the third currency type is associated with minutes of a communication services provider. In accordance with at least one aspect of the above method, the method may include accessing a risk profile associated with the first currency type; and generating the currency transaction fee associated with converting the first currency type to the third currency type based on the risk profile associated with the first currency type. In accordance with at least one aspect of the above method, the risk profile is associated with the first currency type and the third currency type. In accordance with at least one aspect of the above method the currency transaction fee associated with converting the first currency type to the third currency type is based on identifying at least one of the buyer and a seller.

At least one aspect of the present disclosure is directed to a method for performing a single checkout process using multiple currencies. The method may include receiving a first item total in a first currency type, the first item total indicating a subtotal for one or more items associated with the first currency type; receiving a second item total in a second currency type, the second item total indicating a subtotal for one or more items associated with the second currency type; and in response to receiving a third currency type associated with a buyer of the one or more items associated with the first currency type and the one or more items associated with the second currency type, dynamically displaying a transaction total including a currency transaction fee associated with converting the first currency type to the third currency type and a second currency transaction fee associated with converting the second currency type to the third currency type.

In accordance with at least one aspect of the above method, the method may include dynamically displaying the currency transaction fee associated with converting the first currency type to the third currency type in a user interface; and dynamically displaying the currency transaction fee associated with converting the second currency type to the third currency type in the user interface. In accordance with at least one aspect of the above method, the method may include writing the currency transaction fee associated with converting the first currency type to the third currency type to a publicly available ledger; writing the currency transaction fee associated with converting the second currency type to the third currency type to the publicly available ledger; writing a first subsequent currency transaction fee associated with converting the first currency type to the third currency type to the publicly available ledger, the first subsequent currency transaction fee being associated with an actual incurred conversion cost associated with converting the first currency type to the third currency type; and writing a second subsequent currency transaction fee associated with converting the second currency type to the third currency type to the publicly available ledger, the second subsequent currency transaction fee being associated with an actual incurred conversion cost associated with converting the second currency type to the third currency type. In accordance with at least one aspect of the above method, the method may include determining a difference between the currency transaction fee associated with converting the first currency type to the third currency type and the first subsequent currency transaction fee; and providing a credit to an account associated with the buyer when the first subsequent currency transaction fee is less than the currency transaction fee associated with converting the first currency type to the third currency type. In accordance with at least one aspect of the above method, at least one of the first currency type, the second currency type, and the third currency type is a non-nationally recognized currency. In accordance with at least one aspect of the above method, the method may include accessing a risk profile associated with the first currency type; and generating the currency transaction fee associated with converting the first currency type to the third currency type based on the risk profile associated with the first currency type. In accordance with at least one aspect of the above method, the risk profile is associated with the first currency type and the third currency type. In accordance with at least one aspect of the above method, the currency transaction fee associated with converting the first currency type to the third currency type is based on identifying at least one of the buyer and a seller.

At least one aspect of the present disclosure is directed to a system comprising a processor, and memory including instructions, which when executed by the processor, cause the processor to: dynamically display a first item total in a first currency type at a first location in a user interface, the first item total indicating a subtotal for one or more items associated with the first currency type; dynamically display a second item total in a second currency type at a second location in the user interface, the second item total indicating a subtotal for one or more items associated with the second currency type; and in response to receiving a determination of a third currency type associated with a buyer of the one or more items associated with the first currency type and the one or more items associated with the second currency type, dynamically display a transaction total including a currency transaction fee associated with converting the first currency type to the third currency type and a second currency transaction fee associated with converting the second currency type to the third currency type.

In accordance with at least one aspect of the above system, at least one of the first currency type, the second currency type, and the third currency type is a non-nationally recognized currency.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for performing a single checkout process using multiple currencies, the method comprising:
dynamically displaying, via a user interface, a first item total in a first currency type at a first location in a user interface, the first item total indicating a subtotal for one or more items associated with the first currency type;
dynamically displaying, via the user interface, a second item total in a second currency type at a second location in the user interface, the second item total indicating a subtotal for one or more items associated with the second currency type;
receiving, via the user interface, a selection of a third currency type; and
dynamically displaying, via the user interface, a transaction total including a currency transaction fee in the third currency type, the currency transaction fee being associated with converting the first currency type to the third currency type and a second currency transaction fee associated with converting the second currency type to the third currency type.

2. The method of claim 1, further comprising:
dynamically displaying, via the user interface, the currency transaction fee associated with converting the first currency type to the third currency type in the user interface; and
dynamically displaying, via the user interface, the currency transaction fee associated with converting the second currency type to the third currency type in the user interface.

3. The method of claim 2, wherein the currency transaction fee associated with converting the first currency type to the third currency type is displayed as the third currency type, and the currency transaction fee associated with converting the second currency type to the third currency type is displayed as the third currency type.

4. The method of claim 2, wherein the currency transaction fee associated with converting the first currency type to the third currency type is displayed as the first currency type, and the currency transaction fee associated with converting the second currency type to the third currency type is displayed as the second currency type.

5. The method of claim 2, further comprising receiving a determination of a fourth currency type associated with a buyer of the one or more items associated with the first currency type and the one or more items associated with the second currency type, displaying a second transaction total including a currency transaction fee associated with converting the first currency type to the fourth currency type and a second currency transaction fee associated with converting the second currency type to the fourth currency type.

6. The method of claim 1, wherein at least one of the first currency type, the second currency type, and the third currency type is a non-nationally recognized currency.

7. The method of claim 6, wherein the at least one of the first currency type, the second currency type, and the third currency type is associated with minutes of a communication services provider.

8. The method of claim 1, further comprising:
accessing a risk profile associated with the first currency type; and
generating the currency transaction fee associated with converting the first currency type to the third currency type based on the risk profile associated with the first currency type.

9. The method of claim 8, wherein the risk profile is associated with the first currency type and the third currency type.

10. The method of claim 8, wherein the currency transaction fee associated with converting the first currency type to the third currency type is based on identifying at least one of a buyer and a seller.

11. A method for performing a single checkout process using multiple currencies, the method comprising:
receiving, via a user interface, a first item total in a first currency type, the first item total indicating a subtotal for one or more items associated with the first currency type;
receiving, via the user interface, a second item total in a second currency type, the second item total indicating a subtotal for one or more items associated with the second currency type;
receiving, via the user interface, a selection of a third currency type; and
dynamically displaying, via the user interface, a transaction total including a currency transaction fee in the third currency type, the currency transaction fee being associated with converting the first currency type to the third currency type and a second currency transaction fee associated with converting the second currency type to the third currency type.

12. The method of claim 11, further comprising:
dynamically displaying, via the user interface, the currency transaction fee associated with converting the first currency type to the third currency type in a user interface; and
dynamically displaying, via the user interface, the currency transaction fee associated with converting the second currency type to the third currency type in the user interface.

13. The method of claim 11, further comprising:
writing the currency transaction fee associated with converting the first currency type to the third currency type to a publicly available ledger;
writing the currency transaction fee associated with converting the second currency type to the third currency type to the publicly available ledger;
writing a first subsequent currency transaction fee associated with converting the first currency type to the third currency type to the publicly available ledger, the first subsequent currency transaction fee being associated with an actual incurred conversion cost associated with converting the first currency type to the third currency type; and
writing a second subsequent currency transaction fee associated with converting the second currency type to the third currency type to the publicly available ledger, the second subsequent currency transaction fee being associated with an actual incurred conversion cost associated with converting the second currency type to the third currency type.

14. The method of claim 13, further comprising:
determining a difference between the currency transaction fee associated with converting the first currency type to the third currency type and the first subsequent currency transaction fee; and
providing a credit to an account associated with a buyer when the first subsequent currency transaction fee is less than the currency transaction fee associated with converting the first currency type to the third currency type.

15. The method of claim 11, wherein at least one of the first currency type, the second currency type, and the third currency type is a non-nationally recognized currency.

16. The method of claim 11, further comprising:
accessing a risk profile associated with the first currency type; and
generating the currency transaction fee associated with converting the first currency type to the third currency type based on the risk profile associated with the first currency type.

17. The method of claim 16, wherein the risk profile is associated with the first currency type and the third currency type.

18. The method of claim 17, wherein the currency transaction fee associated with converting the first currency type to the third currency type is based on identifying at least one of a buyer and a seller.

19. A system comprising:
a processor; and
memory including instructions, which when executed by the processor, cause the processor to:
dynamically display, via a user interface, a first item total in a first currency type at a first location in a user interface, the first item total indicating a subtotal for one or more items associated with the first currency type;
dynamically display, via the user interface, a second item total in a second currency type at a second location in the user interface, the second item total indicating a subtotal for one or more items associated with the second currency type;
receive, via the user interface, a selection of a third currency type; and
dynamically display, via the user interface, a transaction total including a currency transaction fee in the third currency type, the currency transaction fee being associated with converting the first currency type to the third currency type and a second currency transaction fee associated with converting the second currency type to the third currency type.

20. The system of claim 19, wherein at least one of the first currency type, the second currency type, and the third currency type is a non-nationally recognized currency.
